(19) United States
(12) Patent Application Publication
(10) Pub. No.: US 2004/0260527 A1
(43) Pub. Date: Dec. 23, 2004

(54) Compact and effective representation of simulation results

(76) Inventor: Alexandru G. Stanculescu, San Mateo, CA (US)

Correspondence Address: Dr Alec Stanculescu, 40 Stoney Pt Pl, San Mateo, CA, 94402, US

(21) Appl. No.: 10/465,480

(22) Filed: Jun. 19, 2003

(51) Int. Cl. G06F 17/50

(52) U.S. Cl. 703/14

(57) ABSTRACT

The present invention provides a method and system for representing the simulation results in a much more compact format than the current state of the art and speeds up significantly both the storing of the results and the processing of the database, especially speeding up the comparison of two databases. This is achieved by (1) providing the database with more information which is typically available in the simulator or could easily be made available directly from the design description, and by (2) using the dependency graph of the signals in the database to implement a much faster comparison of two databases.

### FIELD OF THE INVENTION

The present invention relates to the digital simulation of electronic circuits and more specifically to a method and apparatus for storing simulation results in a database for more efficient manipulation of such data, especially for the processing necessary to compare two simulation results databases.

References:

U.S. Pat. No. 4,868,770 titled “Simulation Results enhancement method and system”, filed on Dec. 2, 1987 and awarded on Sep. 19, 1989 is applicable only to analog simulation, in my view, being aimed specifically at interactive analog simulation, and without making any claim regarding the comparison of two databases, claim which is made by the current invention. For digital simulation the above mentioned patent represents just an idea of storing partial simulation results, which cannot be implemented as described (since it is not described in the patent) and this is most likely the reason why no commercial application of this idea exists yet in the digital simulation domain. It is noteworthy that the owner of the U.S. Pat. No. 4,868,770, Mentor Graphics, which acquired Analogy, the assignee of U.S. Pat. No. 4,868,770, also owns a well known digital simulator named ModelSim, but did not, to my knowledge, make any public statement about the use of this idea in the digital simulation domain. The key difficulties in implementing the idea in U.S. Pat. No. 4,868,770 in the digital simulation domain, which are overcome by the current invention, are answers to the following questions:

a) what corresponds in the digital simulation domain to the concept of “elemental modeling subsystem” referenced in U.S. Pat. No. 4,868,770?

b) Which part of the database should be present and which part should be calculated post simulation in case of digital simulation?

c) How should the post simulation completion of the simulation results be implemented?

d) What is the structure of the database?

e) How should the data in the database be represented?

f) What operations on the database should be supported?

Providing the wrong answers to these questions makes the implementation of the idea unworkable. Given the large number of waveforms in digital simulation compared to the number of waveforms in analog simulation one cannot afford to have another simulator in the database for completion purposes.

Further more the stated purpose of the above mentioned patent is to save simulation time by not calculating details that may never be used and calculate those details only when needed in interactive mode, this way slowing down the processing of the results in an acceptable way. In digital simulation the goal is exactly opposite, i.e. the goal is to speed up the processing of the simulation results. This is achieved by decreasing the storage space needed for the simulation results.

The current invention claims its application on a digital system modeled by behavioral, rtl, gate and switch level constructs.

### BACKGROUND OF THE INVENTION

Digital simulations of electronic circuits produce simulation results that are stored in a results database for further processing. This processing may have one of the following goals: (a) display the results in graphical form, (b) compare the results with the ones in another similar database, (c) check the database for certain properties, (d) collect statistical information, etc.

The process of transferring simulation results from a digital simulator to the associated database is done via a functional interface that includes the following functions: (1 ) function to open the database for read and/or write operations, (2) set of functions used to report the full hierarchical name of the signals to be stored in the database, along with their type and size, (3) a function to report a change in a particular signal during the simulation, (4) a function to close the operations in the database. Additional information can be obtained by the simulation results database directly from the description of the circuit in case the simulator does not provide it.

The data representation in the database consists of two main parts: (i) the header which contains information about the signals that are stored in the database (including type, size, and full hierarchical name), as well some commonly used patterns of values, and (2) signal changes, providing information to produce all values that changed and the, time at which each new value occurs.

The volume of the simulation results is growing due to the growing complexity of testing circuits and therefore it becomes increasingly important to store simulation results in the most compact form.

Various simulation results databases have been implemented so far. They all are more or less successful at implementing algorithms based on published compaction/encryption theory.

However, simulation results databases are often not small enough and the processing of such databases takes often times much longer that one would want.

### SUMMARY OF THE INVENTION

The present invention provides a method and system for representing the simulation results in a much more compact format than the current state of the art and makes it possible to speed up significantly both the storing of the results and the processing of the database, especially speeding up the comparison of two databases. This is achieved by (1) providing the database with more information which is typically available in the simulator or could easily be made available directly from the design description, and by (2) using the dependency graph of the signals in the database to implement a much faster comparison of two databases.

The present invention extends the interface to the results database with 20 information coming either from the simulator or directly from the description of the design. Specifically, one has to extend the set of functions needed to report the signals to be stored in the database in such a way that the reporting differentiates between basic signals, auto-generated signals, and derived signals.

Basic signals are treated as before the use of this invention. Auto-generated signals can be described in terms of one simple operation to be performed on the previous value of the signal at given time intervals. Derived signals can be described in terms of simple operations to be performed on the current values of other signals. Auto-generated signals and derived signals do not require the transfer of information from the simulator to the database for each change in their value of the signal during simulation. Note that an auto-generated signal or a derived signal may become a basic signal at some point in time during simulation due to a special condition (switch to interactive simulation, or PLI interaction), and provisions to support this change must be taken, if this feature is to be supported.

Basic signals are treated as before the use of this invention, whereas auto-generated signals and derived signals will contain in their header, in addition to their name, size and type, also the description of the way to reconstruct the entire history of the signal (its waveform) possibly based on the values of other signals.

Not only is the space for storing the derived signals much smaller, but the processing involved in comparing two databases is vastly sped up by performing the following steps: (1) compare the headers of all signals first, (2) compare the values of basic signals, and (3) compare only the derived signals that reference basic signals that are found to differ.

### DETAILED DESCRIPTION OF THE INVENTION (PREFERRED EMBODIMENT)

The present invention is directed to a method and apparatus for minimizing the space necessary to store simulation results and the time necessary to compare the waveforms of signals in two databases. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

According to the present invention, the reduction in the size of the stored simulation results is attained by describing some signals in terms of other signals or in terms of constant values and time intervals. The invention consist in the fact that deriving the values of signals after the simulation is done, saves on storage space for signals that are used at most temporarily after the simulation is done, which in turn saves the time necessary to load the database in memory. This advantage far exceeds the disadvantage of having to compute, when needed, the derived signals after the data is stored in the database. Especially sped up is the comparison between two simulation results databases, since the comparison can be performed first on headers of signals, then on basic signals, and only last on the derived signals that reference directly or indirectly basic signals that proved to be different during the comparison of the basic signals, thus saving the time necessary to compare signals that have the same headers and are derived from the same signals which show no differences in the two databases.

The present invention is described below in further detail, with reference to an implementation specified in pseudo code. One skilled in the relevant art, however, will readily recognize that the invention can be practiced in a slightly different way, without one or more of the specific details, or with other methods, etc. In other instances, well-known structures or operations are not shown in detail to avoid obscuring the invention.

Detailed Description of a generic embodiment of the invention:

```
/*****************************************************/
/* Incomplete list of auto-generate operators: */
/****************************************************/
1.  Oscilate(name, type, posDuration, negDuration, initialValue)
    - name: name of signal whose value oscilates
    - posDuration: length of time during which the signal has the logical value of
      one.
    - negDurationl: length of time during which the signal has the logical value of
      zero.
    - initialValue: value of signal at time zero.
2.  Not (name, nameBar)
      - name: name of signal whose value is being negated in order to
        obtain the value of the signal nameBar.
      - nameBar: name of derived signal.
3.  Alias (name, aliasName)
    - name: signal handle of original signal
    - aliasName: signal handle of signal that has the same values and times at
      which changes occur as the signal indicated by the first argument, name
4.  Shift(name, type, kind, size, direction, interval)
    - name: signal handle of signal whose value shifts at each time interval
    - kind: kind of shift (e.g. circular, linear arithmetic, linear unsigned)
    - size: number of bits in the signal
    - direction: left, right
    - timeInterval: time interval after which the signal shifts its value
/************************************************************/
/* Incomplete list of unary derivation operators */
/************************************************************/
5.  Delay (name, named, type, size, delay)
    - name: signal handle of original signal
    - named: signal handle of signal that is delayed
/****************************************************************/
/* Incomplete list of non-unary derivation operators */
/****************************************************************/
6.  AND(nameOut, list of signal handles)
7.  OR(nameOut, list of signal handles)
8.  XOR(nameOut, list of signal handles)
9.  NAND(nameOut, list of signal handles)
10. NOR(nameOut, list of signal handles)
11. ADD(nameOut, in1, in2);
12. SUB(nameOut, in1, in2);
13. MULT(nameOut, lin1, in2);
14. DIV(nameOut, lin1, in2);
  Where nameOut, in1, in2 represent signal handles which allow full access to
the corresponding signal header in the database. NameOut represents the
name of the derived signal and In1 and In2 represent the signals used to derive
nameOut.
/******************************************************************************************/
/* Partial Functional Interface between simulator and results database: */
/******************************************************************************************/
1.  dbOpen(name);
      open database called name
2.  dbClose(name);
      close database called name
3.  dbRoot( );
      changes current scope to root
4.  dbSetScope(hierarchicalName)
      changes current scope to the specified full-hierarchical name.
5.  dbDown(scopeName);
      changes current scope to its child called scopeName,
6.  dbUp( );
      changes current scope to its parent
7.  dbListScopes( );
      list sub-scopes in current scope
8.  dbCreateScope(name);
      creates sub-scope named name in current scope
9.  dbCreateBasicSignalInCurrentScope(name, type, handle);
      name: signal name
      type: signal type
      handle: returned handle to newly created signal
10.  dbCreateAutoSignalInCurrentScope(name, type, handle, auto-
                    generate_structure);
      name: signal name
      type: signal type
      handle: returned handle to newly created signal
      auto-generate_structure: pointer to auto-generate operator and
                    associated information.
11. dbCreateDerivedSignalInCurrentScope(name, type, derivation_structure);
      name: signal name
      type: signal type
      handle: returned handle to newly created signal
      derivation_structure: expression that uses derivation operators and
                    signal handles
12. dbSwitchToBasicSignal(name);
      changes the kind of a signal from auto-generate or derived to basic
13. dbGetAllChangesAtCurrentTimepoint(name, value);
14. dbReportAllChangesAtCurrentTimePoint(name, value);
15. dbGetCurrentTime(Time, [optionalDeltaCnt]);
16. dbReportCurrentTime(Time, [optionalDeltaCnt]);
/***************************************************************/
/* Elements of the Data Structure of the Database: */
/***************************************************************/
1.  dbHeaderT
      tree of scopes, each containing sub-scopes and signal heders
2.  dbSignalHeaderT
      name: name of signal
      type: type of signal (e.g. integer, real, reg, signed integer, struct, array,
        etc)
        pointer to type declaration
    kindP: pointer to data structure indicating kind of signal (e.g. basic, auto-
        generate, derived, partially-auto, partially-derived) and all
        associated information (e.g. expression for signal derivation, or
        info for auto-generate).
    time: time after which this signal becomes basic signal after being auto-
      generate or derived
    waveP: pointer to info about value changes and times at which they occur
          for the given signal.
3.  dbPatternsT
      sequence of signal values and delays that can be easily checked for a
      match via hash table and replaced for compaction purposes by the index
    in the hash table.
4.  dbValueChangesT
      value (including strength) , time, optionally delta count
      /*******************************************/
      /* Algorithm for writing into database: */
      /*******************************************/
      Step 1: If necessary, simulator calls database to report that some auto-generate
or derived signals have become basic signals. Optionally, the type can become
partially-auto or partially-derived, with the time of change associated in the header of
the signal. This means that either (1) the signal is transformed into a basic signal by
computing all the changes in its values up to the time of change and storing them as
for all basic signals, or (2) the signal is kept in the format of an auto-generate or
derived signal up to the time of its change into a basic signal and only from that time
are all the value changes stored as for basic signals.
      Step 2: Simulator calls database to report the current time and a list of changes
in values of basic signals. For each signal for which a change is reported write the
individual change in the database. Check whether the given change appended to the
current “recent history” of the signal matches an existing pattern, or whether it should
become a new pattern to be stored, or weather one should postpone the decision to
create a new pattern because further value changes may lead to an existing pattern. .
If an existing pattern is recognized, a reference to the pattern shall replace the
references to each of the value changes in the recent history that comprise the newly
recognized pattern of changes.
    /******************************************************************************/
    /* Algorithm for loading all signal value changes of derived and */
    /* auto-generate signals in memory for fast processing (e.g. */
    /* displaying on screen or comparing to another signal). */
    /******************************************************************************/
/* Void dbLoadSignal(signalHandleT S);
    signalHandleT S;
    Step 1: If not already cashed in memory, load from the database the
    information associated to signal S, namely: (1) header, including: type(e.g.
    integer, real, reg, wire, signed integer, signed reg) , size, kind (e.g. basic, auto-
    generate, derived), and if the kind is auto-generate or derived, the operators
    applied and their actual operands.
    Step 2: CASE S is
    Basic: getWaveform For(S);
    Auto: computeAutoFor(S);
    Derived: BEGIN
        GetListOfReferencedSignals(S, List);
        WHILE IsNotEmpty(List)
          BEGIN
            RemoveSignalFromList(List, Sig);
            loadSignal(Sig);
          END
        ComputeDerivedFor(S);
      END
    Where:
    - getWaveform brings in memory for fast processing all changes in value
      and the times at which such changes occur of the given signal.
    - computeAuto computes all the changes in the value of the given
      auto-generate signal by using the information in its header
    - computeDerived computes all the changes in the value of the given derived
      signal by using the information in its header and the referenced signals that
      are already loaded in memory according to the present algorithm.
    */
  /******************************************************************************/
  /* Algorithm for loading all signal value changes of derived, */
  /* auto-generate, partially derived, and partially auto-generate */
  /* signals in memory for fast processing (e.g. */
  /* displaying on screen or comparing to another signal). */
  /******************************************************************************/
/* Void dbLoadSignalXL(signalHandleT S);
    signalHandleT S;
    Step 1: If not already cashed in memory, load from the database the
    information associated to signal S, namely: (1) header, including: type(e.g.
    integer, real, reg, wire, signed integer, signed reg) , size, kind (e.g. basic, auto-
    generate, derived, partially auto-generate, partially derived), and if the kind is
    auto-generate, partially auto-generate, partially derived, or derived, the
    operators applied and their actual operands.
    Step 2: CASE S is
    Basic: getWaveform For(S);
    Auto: computeAutoFor(S);
    PAuto: BEGIN
        computAutoPartFor(S);
        getWaveformForRestOf(S);
      END
    Derived: BEGIN
        GetListOfReferencedSignals(S, List);
        WHILE IsNotEmpty(List)
          BEGIN
            RemoveSignalFromList(List, Sig);
            loadSignal(Sig);
          END
        ComputeDerivedFor(S);
      END
    PDerived: BEGIN
        GetListOfReferencedSignals(S, List);
        WHILE IsNotEmpty(List)
          BEGIN
            RemoveSignalFromList(List, Sig);
            loadSignal(Sig);
          END
        ComputeDerivedPartFor(S);
        getWaveformForRestOf(S);
      END
    Where:
    - getWaveform brings in memory for fast processing all changes in value
      and the times at which such changes occur of the given signal.
    - getWaveformForRest brings in memory for fast processing all the values
      changes and the times at which they occur for signals that became basic
      signals during the simulation at a time stored in the header of the signal.
    - computeAuto computes all the changes in the value of the given
      auto-generate signal by using the information in its header and brings all
      the changes and the times at which they occur in memory for fast
      processing.
    - computeAutoPartFor computes all the changes in value and the times at
      which they occur for a partially auto-generate signal up to the time that it
      became a basic signal.
    - computeDerived computes all the changes in the value of the given derived
      signal by using the information in its header and the referenced signals that
      are already loaded in memory according to the present algorithm, and
      stores them in memory along with the times at which they occur for fast
      processing.
    - computeDerivedPartFor computes all the changes in the value of the given
      partially derived signal up to the time at which it became a basic signal.
  */
  /************************************************************************************/
  /* Algorithm for comparing two databases: */
  /***********************************************************************************/
/*  The data structure of the results database shall have each signal pointing to
two linked lists: a list of signals upon which the given signal depends and a list of
signals that depend on the given signal.
The method consists of the following steps applied to the simulation results
database:
Step 1: Load and compare all signal headers of the two databases.
Step 2: Load and compare all signal value changes for all basic signals that have
identical headers in both databases.
Step 3: Make a list of all derived signals that have identical headers in both
databases and that depend directly or indirectly (i.e. via other derived signals) on
basic signals with different headers in the two databases or whose list of value
changes and times were found different in the two databases at Step 2), or on
auto-generate signals that have different headers in the two databases.
Step 4: Rank the signals in the list made at step c) giving each signal a number
equal to the maximum of the numbers associated to each of the signals which it
references plus one, with the convention that basic and auto-generate signals
have associated the rank of zero. Thus a signal that depends only on basic or
auto-generate signals has a rank of one.
Step 5: Associate to each signal a cap, representing the number indicating the
highest rank of any signal that depends upon it. Link together all signals with the
same cap number.
Step 6: Call CompareSignalFrom2Databases for all signals in increasing order of
their rank. Each time the rank changes free the memory of the signals having the
cap equal to the previous rank.
    */
```

What is claimed is:

1 A method for providing more information to the digital simulation results database, either from the simulator or directly from the description of the circuit being simulated, resulting in a more compact representation of the database and a more efficient processing of the data stored in it, the method comprising the steps of:
(a) declare to the database which of the signals are basic signals, whose changes in values must be stored as they are reported by the simulator.
(b) declare to the database which signals are auto-generate signals and what is the way to generate all their changes in value without needing information from any other signal.
(c) declare to the database which signals are derived from other signals and the way to generate all their changes in value without needing information from any other signal except of those referenced in the declaration.
(d) report to the database transactions, each transaction consisting of (1) signal identifier, (2) signal value (including strengths information if necessary), (3) time at which the change occurred, and optionally (4) delta count as partial order information, where signal identifier must be identifying a basic signal.

2 The method of claim 1 further including the method of (i) loading in memory all the value changes and the times at which each change occurs for a derived signal that does not depend directly or indirectly upon a delayed copy of itself (it is suggested to declare dependency loop breakers as basic signals), or (ii) loading in memory all the value changes and the times at which each change occurs for an auto-generate signal that is stored in the database, method consisting of the steps included in the recursive function dbLoadSignal, presented in the detailed description of the invention.

3 The method of claim 2 further including the method for getting the information regarding which signals are basic, auto-generate and derived (steps a, b, c of described in claim 1) directly from the design description rather than from the simulation and accepting transactions from the simulators for all signals. By discarding transactions for auto-generate or derived signals the data base can be significantly compacted.

4 The method of claim 2 further including the method for faster comparison of two simulation results databases, by first comparing the headers of the two databases, then the basic signals which have similar headers, and only afterward compare the derived signals that reference directly or indirectly only basic signals that are different in the two databases, thus saving the time necessary to compare signals that have similar header information, and that depend on signals that have identical history of changes of their values.
Each signal in the results database shall point to two linked lists: one of signals upon which it depends and another one of signals that depend on it.
The method consists of the following steps applied to the simulation results database:
a) Load and compare all signal headers of the two databases.
b) Load and compare all signal value changes for all basic signals that have identical headers in both databases.
c) Make a list of all derived signals that have identical headers in both databases and that depend directly or indirectly (i.e. via other derived signals) on basic signals with different headers in the two databases or whose list of value changes and times were found different in the two databases at step b), or on auto-generate signals that have different headers in the two databases.
d) Rank the signals in the list made at step c) by giving each signal a number (a rank) equal to the maximum of the ranks associated to each of the signals which it references plus one, with the convention that basic and auto-generate signals have associated the rank of zero. Thus a signal that depends only on basic or auto-generate signals has a rank of one.
e) Associate for each signal a cap, representing the number indicating the highest rank of any signal that depends upon it. Link together all signals with the same cap number.
Process all derived signals in increasing order of their rank by (i) loading in memory all their changes in value and the time at which the changes occur in both databases, by calling the function dbLoadSignal for the corresponding signal in each database, and (ii) Call the function CompareSignalFrom2Databases, which compares the value changes and the occurrence time for each change for the same signal in the two databases. Each time the rank changes, free the memory of the signals having the cap equal to the previous rank.

5 The method of claim 3 further including the method for faster comparison of two simulation results databases, by first comparing the headers of the two databases, then the basic signals which have similar headers, and only afterward compare the derived signals that reference directly or indirectly only basic signals that are different in the two databases, thus saving the time necessary to compare signals that have similar header information, and that depend on signals that have identical history of changes of their values.
Each signal in the results database shall point to two linked lists: one of signals upon which it depends and another one of signals that depend on it.
The method consists of the following steps applied to the simulation results database:
f) Load and compare all signal headers of the two databases.
g) Load and compare all signal value changes for all basic signals that have identical headers in both databases.
h) Make a list of all derived signals that have identical headers in both databases and that depend directly or indirectly (i.e. via other derived signals) on basic signals with different headers in the two databases or whose list of value changes and times were found different in the two databases at step b), or on auto-generate signals that have different headers in the two databases.
i) Rank the signals in the list made at step c) by giving each signal a number (a rank) equal to the maximum of the ranks associated to each of the signals which it references plus one, with the convention that basic and auto-generate signals have associated the rank of zero. Thus a signal that depends only on basic or auto-generate signals has a rank of one.
j) Associate for each signal a cap, representing the number indicating the highest rank of any signal that depends upon it. Link together all signals with the same cap number.
Process all derived signals in increasing order of their rank by (i) loading in memory all their changes in value and the time at which the changes occur in both databases, by calling the function dbLoadSignal for the corresponding signal in each database, and (ii) Call the function CompareSignalFrom2Databases, which compares the value changes and the occurrence time for each change for the same signal in the two databases. Each time the rank changes, free the memory of the signals having the cap equal to the previous rank.

6 The method of claim 2 further including the capability of supporting partially derived or auto-generate signals (i.e. signals that change their property of being auto-generate or derived at a certain time during the simulation). This method must include the step for efficiently (i.e. only when needed) checking whether the given signal maintains its property. This check must be performed whenever a transaction on the signal is reported during a non pre-analyzed situation, such as during interactive simulation or from a PLI for which there was not enough information at compile time to decide that this PLI call may affect the kind of certain signals.
The method of claim 2 must be enhanced for the purpose of loading a signal in memory for fast processing by replacing the function dbLoadSignal with dbLoadSignalXL.

7 The method of claim 3 further including the capability of supporting partially derived or auto-generate signals (i.e. signals that change their property of being auto-generate or derived at a certain time during the simulation). This method must include the step for efficiently (i.e. only when needed) checking whether the given signal maintains its property. This check must be performed whenever a transaction on the signal is reported during a non pre-analyzed situation, such as during interactive simulation or from a PLI for which there was not enough information at compile time to decide that this PLI call may affect the kind of certain signals.
The method of claim 2 must be enhanced for the purpose of loading a signal in memory for fast processing by replacing the function dbLoadSignal with dbLoadSignalXL.

8 The method of claim 4 further including the capability of supporting partially derived or auto-generate signals (i.e. signals that change their property of being auto-generate or derived at a certain time during the simulation). This method must include the step for efficiently (i.e. only when needed) checking whether the given signal maintains its property. This check must be performed whenever a transaction on the signal is reported during a non pre-analyzed situation, such as during interactive simulation or from a PLI for which there was not enough information at compile time to decide that this PLI call may affect the kind of certain signals.
The method of claim 2 must be enhanced for the purpose of loading a signal in memory for fast processing by replacing the function dbLoadSignal with dbLoadSignalXL.

9 The method of claim 5 further including the capability of supporting partially derived or auto-generate signals (i.e. signals that change their property of being auto-generate or derived at a certain time during the simulation). This method must include the step for efficiently (i.e. only when needed) checking whether the given signal maintains its property. This check must be performed whenever a transaction on the signal is reported during a non pre-analyzed situation, such as during interactive simulation or from a PLI for which there was not enough information at compile time to decide that this PLI call may affect the kind of certain signals.
The method of claim 2 must be enhanced for the purpose of loading a signal in memory for fast processing by replacing the function dbLoadSignal with dbLoadSignalXL.
